(19) United States
(12) Patent Application Publication
(10) Pub. No.: US 2006/0249440 A1
(43) Pub. Date: Nov. 9, 2006

(54) Collapsible process tank for a water purification system

(76) Inventors: Adam Kaminski, Ancaster (CA); Frederick Jerome Daly, Burlington (CA); Warren Bruce Lee, Burlington (CA); Michael Perrin Bowring, Brantford (CA)

Correspondence Address: JAECKLE FLEISCHMANN & MUGEL, LLP, 190 Linden Oaks, ROCHESTER, NY, 14625-2812, US

(21) Appl. No.: 11/185,175

(22) Filed: Jul. 20, 2005

Related U.S. Application Data
(60) Provisional application No. 60/592,146, filed on Jul. 30, 2004.
(60) Provisional application No. 60/613,222, filed on Sep. 28, 2004.

(51) Int. Cl. B01D 63/00

(52) U.S. Cl. 210/321.6; 210/483; 210/321.69; 210/436; 210/321.88

(57) ABSTRACT

The invention provides an apparatus having a tank having at least a portion of its surface collapsible such that the tank can be configured in either a deployed position or a smaller stored position. A membrane module is located in the tank. The tank has a feed inlet and a permeate port in communication with the membrane module. When in the deployed position, water enters the inlet and flows through the membrane and out the permeate port in a filtration process. When filtration is no longer required, the tank can be collapsed for transport. The membrane module may remain in the tank when the tank is collapsed.

This is an Application claiming the benefit under 35 USC 119(e) of U.S. Ser. Nos. 60/592,146 filed Jul. 30, 2004 and 60/613,222 filed Sep. 28, 2004. U.S. Ser. Nos. 60/592,146 and 60/613,222 are incorporated herein, in their entirety, by this reference to them.

### FIELD OF THE INVENTION

The invention relates to water purifications systems, and in particular, to a collapsible tank which may contain filtering membranes and be used for a water treatment system.

### BACKGROUND OF THE INVENTION

Numerous water purification systems are known. One known type of water purification systems are mobile or portable systems which are designed to be transportable from place to place by vehicles.

One such portable system is disclosed in U.S. Pat. No. 6,120,688. The system disclosed includes a rigid tank which is made of material, such as stainless steel, aluminum, polyethylene or the like. The process tank and system disclosed in the patent have the disadvantage of requiring a large vehicle for transportation thereof. Typically, such a system requires a 5/4 ton or greater class of vehicle. In certain applications, such as the military, it is desirable to provide a water purification system and process tank which can be transported by a smaller vehicle, such as a HUMWV (High Mobility Multipurpose Wheeled Vehicle).

Accordingly, there is a need for a process tank and a water purification system with improved portability, such as those which can transported by smaller vehicles.

### SUMMARY OF THE INVENTION

The following summary is intended to introduce the reader to the invention but not to define it. The invention may reside in any novel or inventive combination of apparatus elements or process steps found in any part of this document. An object of the invention is to improve on, or at least provide a useful alternative to the prior art. Other objects of the invention are to provide a process or membrane tank or a water treatment system or process.

The present invention provides the advantage of a process or membrane tank with at least a collapsible portion. The tank may be manufactured from a flexible material and the entire tank may be collapsible.

In one aspect, the invention provides an apparatus having a tank having at least a portion of its surface collapsible such that the tank can be configured in either a deployed position or a smaller stored position. A membrane module is located in the tank. The tank has a feed inlet and a permeate port in communication with the membrane module. When in the deployed position, water enters the inlet and flows through the membrane and out the permeate port in a filtration process. When filtration is no longer required, the tank can be collapsed for transport. The membrane module may remain in the tank when the tank is collapsed. For example, the membrane module may comprise hollow fiber membranes which may be rolled or folded with the tank. The ends of the membrane module may be held in the tank by connectors that facilitate collapsing the tank with the membrane module inside. The tank may have a retentate outlet for feed and bleed filtration or for filtration according to cycles of dead end filtration and tank deconcentration. The apparatus may also include an aerator and vent to permit gas scouring the membrane module. The aerator may be at least partially integral with the tank.

### BRIEF DESCRIPTION OF THE DRAWINGS

In the accompanying drawings:

FIG. 1A is a perspective view of a first embodiment of a process tank according to the present invention.

FIG. 1B is an elevation view of the first embodiment.

FIG. 2 is an exploded perspective view of a second embodiment of a process tank according to the present invention.

FIG. 3 is an elevation of view of the second embodiment.

FIG. 4 is an elevation view of a header according to the second embodiment.

FIG. 5 is a partial exploded perspective view of the second embodiment showing the connection of a header to a support frame.

FIG. 6 is a cross-sectional view of the header of FIG. 4 showing an adaptor bracket for connecting a membrane to the header.

### DETAILED DESCRIPTION OF THE INVENTION

An apparatus according to the embodiments described herein is suitable for use in the reverse osmosis water purification system disclosed in U.S. Pat. No. 6,120,688 (the '688 Patent). Accordingly, the entire specification of the '688 Patent is included by reference herein. The tank of the present invention may be used to replace the membrane tank disclosed in the '688 Patent. Alternately, the invention may be used with other water treatment processes or systems.

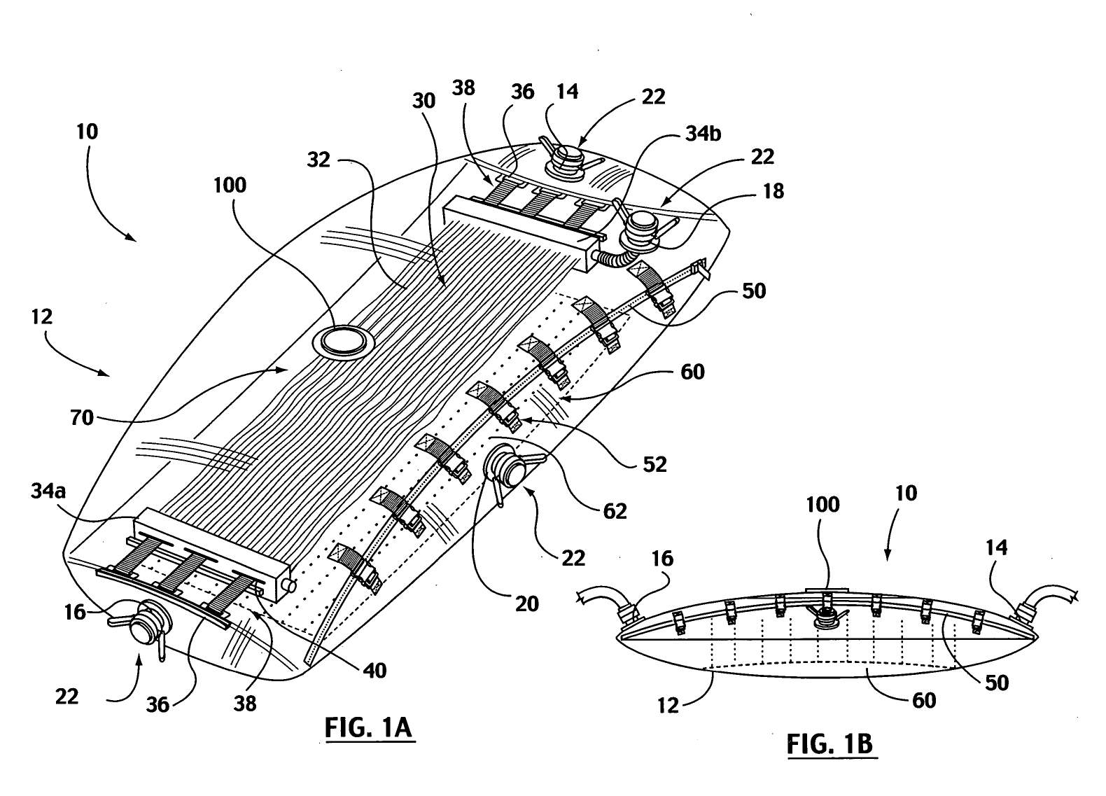

FIGS. 1A and 1B show a process or membrane tank 10 according to a first embodiment of the present invention. The tank 10 includes a tank surface 12. The tank surface 12 may be composed entirely or generally of a flexible material, such as urethane coated fabric. When filled with raw water, the tank surface 12 forms a pillow shape, as shown in FIGS. 1A and 1B. Optionally, only a portion of the tank surface 12 may be composed of a flexible or collapsible material, and the remainder of the tank surface may be composed of a rigid material.

A raw water feed inlet 14, a raw water discharge outlet 16, a permeate port 18, and an air inlet 20 are all located on the tank surface 12. Camlok fittings 22 are provided on each of the above ports 14, 16, 18, and 20 to facilitate connection to corresponding hoses or lines (for example as described in the '688 Patent).

Continuing to refer to FIGS. 1A and 1B, a membrane module 30 is located in the process tank 10. The membrane module may include a plurality of hollow fiber membranes in the form of a rectangular bundle suspended between first and second headers 34a and 34b, respectively. The rectangular bundle may be between four and twelve layers of membranes deep, and in the range of several tens of membranes wide. The membranes may have an outside diameter of 0.4 mm to 4.0 mm. The length of the membranes may be between 400 mm and 1800 mm. The membranes may have an average pore size in the microfiltration or ultrafiltration range, for example between 0.003 microns and 10 microns or between 0.02 microns and 1 micron. The membrane module may be as described in US Patent Publication No 2002/0179517 A1 which is incorporated herein in its entirety by this reference to it.

A permeate cavity or conduit (not shown) is provided in the interior of second solid body 34b. The permeate conduit transports permeate from the interior of the membranes 32 to permeate port 18.

Loop restraint anchors 36 are connected to the tank surface 12 at opposing ends of the tank 10. Elastomeric bungee element restraints 38 are connected to the anchors 36 at one end and to slots 40 milled in the headers 34a,b at the other end to position the membrane module 30 in the tank 10.

Continuing to refer to FIGS. 1A and 1B, a watertight zipper 50 is provided in the tank surface 12. Preferably, the zipper 50 is located along the compression stress line of the tank surface 12. Any suitable number of tension restraints 52 are connected to the tank surface 12 on either side of the zipper to reduce the tension force acting on the zipper 50.

An aerator 60 is located in the tank 10. The aerator 60 is connected to the air inlet 20. A number of grommet vents 62 are located in the aerator 60 to diffuse air or other gases supplied to the aerator 60 through air inlet 20 into the tank 10. The aerator 60 may be composed of the same flexible material as the tank surface 12.

A flush gas vent 100 is provided in the tank surface 12 to permit gas introduced through the aerator membrane 60 to be released from the tank 10. The gas vent 100 may be or operate as a one way valve allowing gas to escape, but not enter, the tank 10.

The operation of the process tank 10 according to the first embodiment will now be described with reference to FIGS. 1A and 1B. The flexible material of the tank surface 12 permits the tank 10 to be collapsed to allow the tank 10 and other components of a water treatment system (for example a feed pump or hose, a permeate pump or siphon hose, an air pump if desired, and valves or control devices if desired) to be transported to a desired location by a vehicle, such as a HUMWV. At the desired location, the system (not shown) is assembled and connected to a source of raw water. Feed flow to the tank 10 may be by gravity or pump. Permeate may be drawn from the membrane module 30 by pump, gravity flow or siphon. Air for air scouring may be provided by air pump or blower if desired from time to time, continuously, intermittently or during or near relaxation, backwashing or deconcentration processes. Permeation may be by dead end filtration, feed and bleed filtration, or cycles of dead end filtration and deconcentration. Backwashing may be performed, if desired, by elevating a permeate tank to above the tank 10 or by pump from a permeate tank to permeate port 18. Control may be by automatic or manual valves, turning pumps on or off, or altering the relative elevation of one or more of a feed tank, the tank 10 or a permeate tank.

In one process, the raw water enters the tank 10 by pump or gravity from a flow source of surface or well water via the feed inlet 14 and fills the tank. When filled with raw water, the tank surface 12 expands to the deployed position and assumes the pillow shape.

A suction may be applied to permeate port 18, for example by pump or siphon, to draw the water into the interior of membranes 32, in order to filter, for example microfilter or ultrafilter, the water. The permeate travels from the interior of the membranes 32 into the conduit in second header 34b, and into permeate port 18. Excess raw water may be discharged from discharge outlet 16 back into the raw water source, to the ground or for irrigation use.

Air from an air source (not shown), such as an air blower, may be diffused into the tank 10 from grommet vents 62 of aerator 60. The air may directly scrub the membranes 32 or operate to induce movement to water contacting the outside of membranes 32 to effect cleaning of the membranes 32. Depending on the membranes 32 used, movement may be induced to the membranes 32. In other words, percolation of the air may cause the membranes 32 to sway or move in the tank 10, thereby effectively cleaning the membranes 32.

Flow of retentate through discharge outlet 16 may be controlled by sizing or valving the discharge outlet 16 to give a feed and bleed flow of 0 to 10% of the feed flow or to provide no bleed flow during some periods of time but drain at least a portion of the tank 10 rapidly from time to time to deconcentrate it. The gas vent 100 may have a restricted opening size so as to trap a cushion of gas under the gas vent 100 such that water will not escape the tank 10 even if feed or in tank 10 pressure temporarily or continuously exceeds the static head in the tank 10. However, the tank 10 is not intended to be pressurized to a large degree, for example not more than 50% over ambient pressure.

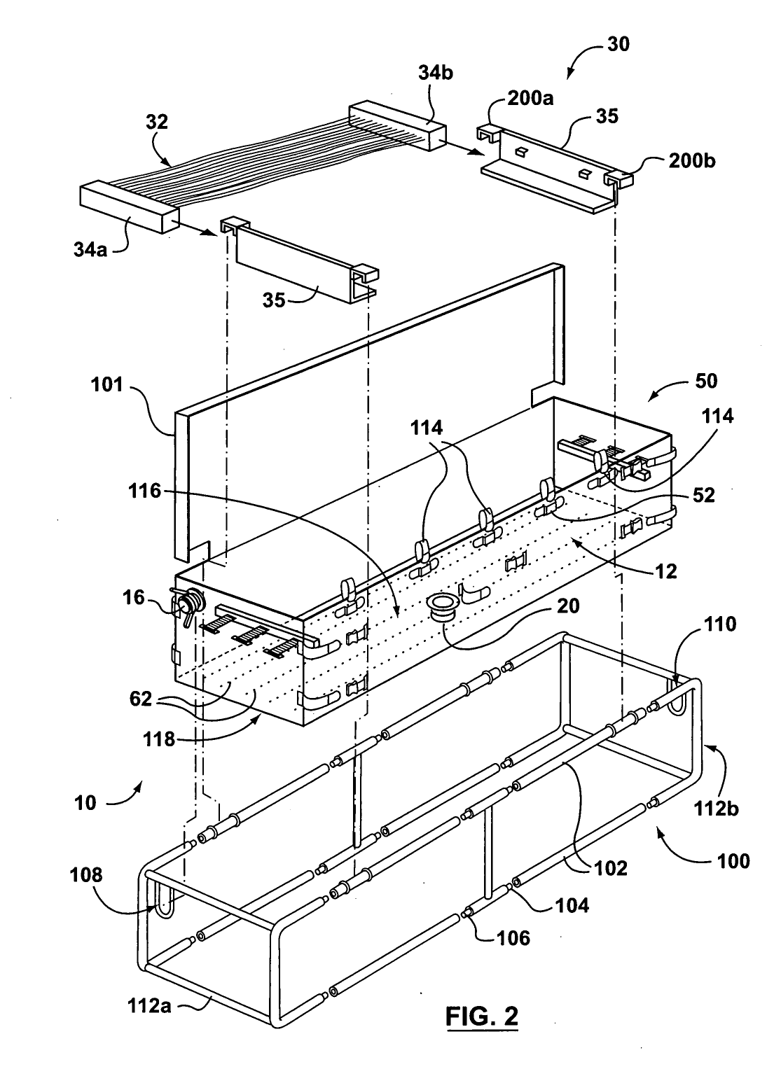

FIG. 2 shows a second embodiment of the present invention where a support frame 100 is provided to give the tank surface 12 a predetermined shape. The predetermined shape may be a box-like shape where the tank surface 12 includes a tank lid flap 101 which may be integral with the rest of the tank 10. Like parts in this second embodiment will be assigned the same reference numbers as the corresponding parts in the first embodiment, and will not be further described.

Referring to FIG. 2, the support frame 100 consists of a number of interconnectable support members 102 which are assembled into the support frame 100. When the tank 10 is in the stored position, the support members 102 may be disassembled and stored in a more compact fashion. Preferably, the support members are 6061-T6 aluminum tubes having an outside diameter of 1″. Some of the support members 102 may include conventional male connections 104 and others may include female connections 106 to secure the support members 102 to each other by an interference fit.

Discharge hose support 108 and feed hose support 110 may be provided on end pieces 112a, 112b, respectively, of support members 102.

Support straps 114 are preferably connected to the exterior of tank surface 12 to attach the support frame 100 to the exterior of the tank surface 12.

Continuing to refer to FIG. 2, an integral aerator 116 is provided in a bottom portion 118 in the tank surface 12. The aerator 116 is connected to air inlet 20.

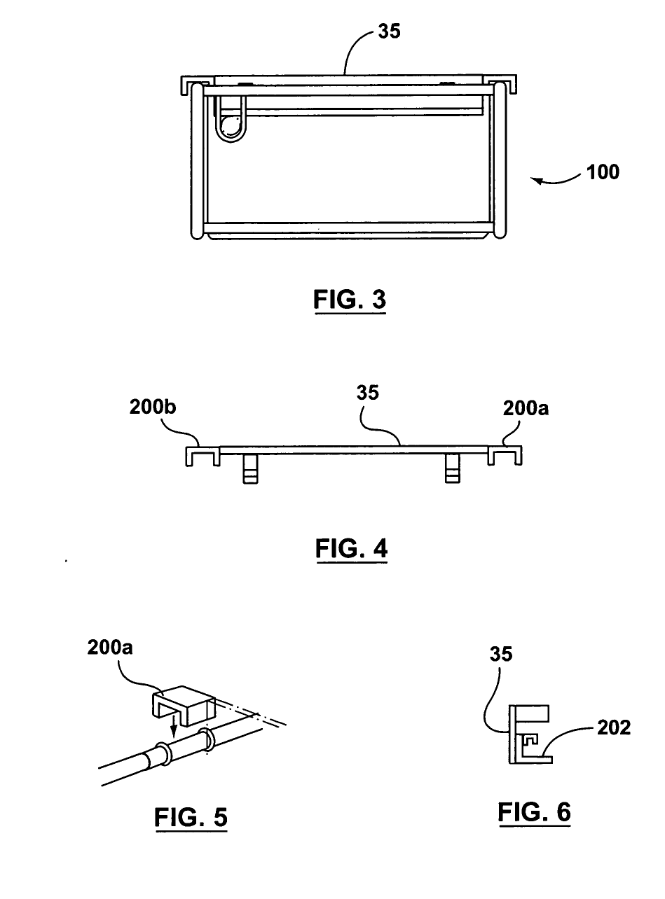

Referring to FIGS. 3-6, the solid bodies 34a,b are preferably connected to stainless steel support bracket assemblies 35 which include inverted channel sections 200a, 200b. The solid bodies 34a,b are supported on support frame 100 by the inverted channel sections 200a,b which engage the support frame 100. While FIGS. 3-6 show only one bracket assembly 35, the other is supported on the support frame 100 in an identical fashion.

Referring now to FIGS. 2 and 6, each end of the membrane 32 is connected through solid bodies 34a,b to bracket assemblies 35 by an adapter bracket 202. This adapter bracket 202 slides into a slot (not shown) located in the solid bodies 34a,b and is connected to the solid bodies 34a,b for example by conventional screws, nuts, and washers.

The operation of the second embodiment of the process tank 10 according to the present invention will now be described.

The tank 10 is transported to the desired location in the collapsed position. In other words, the flexible tank surface 12 is collapsed or folded and the support frame 100 is disassembled into the individual support members 102. During transport, a zipper 50 between the lid 101 and the remainder of the tank 10 is preferably closed to maintain an airtight seal between the tank flap lid 101 and the tank 100 in order to provide a moist environment which is desirable for the membrane 32.

Upon arrival at the desired location, the support frame 100 is assembled at the desired location by connecting the male connections 104 to female connection 106 of the various support members 102.

The tank 10 is positioned within the support frame 100, and secured by the support straps 114. In this manner, the support frame 100 forms an external support structure for the tank 100. The zipper 50 is opened to provide access to the interior of the tank 10. The headers 34a,b are connected to the bracket assemblies 35 and placed on the support frame 100 as described above.

The tank 10 is filled up with water as described for the first embodiment above. The support frame 100 causes the tank 10 to assume the box-like shape when filled with raw water. The membrane 32 is suspended above the bottom of the tank 10 and below the surface of the raw water. The tank lid flap 101 remains either fully or partially open during operation to permit air introduced into the tank 10 by the aerator membrane 116 to vent. In other respects, the process tank 10 operates as described for the first embodiment above.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims.

1. An apparatus for a water treatment system comprising:
a) a tank having a tank surface, wherein at least a portion of the tank surface is collapsible between a deployed position adapted to store raw water, and a stored position wherein the portion is collapsed and the tank has a volume smaller than the deployed position;
b) a feed inlet located in the tank surface for receiving raw water;
c) a membrane module located in the tank; and,
d) a permeate port located in the tank surface, the permeate port being in fluid communication with the membrane module.

2. The apparatus of claim 1, wherein the portion is composed of a flexible material.

3. The apparatus of claim 1, wherein the tank surface is composed of the flexible material.

4. The apparatus of claim 3, further comprising a removable support frame, the tank surface being adapted to connect to the support frame to form the tank surface into a predetermined shape when in the deployed position.

5. The apparatus of claim 4, wherein the support frame comprises a plurality of interconnectable support members, the support members being adapted for compact storage when the tank surface is in the stored position.

6. The apparatus of claim 5, wherein the predetermined shape is a box like shape.

7. The apparatus of claim 6, wherein the support frame is located exteriorly of the tank surface when in the deployed position.

8. The apparatus of claim 1 further comprising an aerator and a gas port in communication with the aerator.

9. The apparatus of claim 1 wherein the membrane module comprises first and second solid bodies and a plurality of hollow fiber membranes extending between the solid bodies.

10. The apparatus of claim 9 having connectors between the solid bodies and the tank.

11. The apparatus of claim 1 wherein the portion is collapsible by rolling.

12. The apparatus of claim 9 wherein the portion is collapsible by rolling about one of the solid bodies.

13. The apparatus of claim 8 wherein a portion of the tank surface functions as a part of the aerator.

14. The apparatus of claim 9 having an aerator with holes located between the first and second solid bodies.

15. The apparatus of claim 1 wherein the tank surface comprises one or more zippers.

16. The apparatus of claim 15 having a tension restraint to reduce tension on a zipper.

17. The apparatus of claim 10 wherein the connectors are elastomeric.

18. The apparatus of claim 1 wherein the tank has a pillow like shape in the deployed position.

19. The apparatus of claim 1 wherein the tank has a gas vent.

20. The apparatus of claim 1 having a discharge outlet.
